(19) United States
(12) Patent Application Publication
(10) Pub. No.: US 2004/0093993 A1
(43) Pub. Date: May 20, 2004

(54) Wrench with rollers movably engaged with wedge-shaped gaps between head and engaging ring

(76) Inventor: Chih-Ching Hsien, Taichung (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/298,532

(22) Filed: Nov. 19, 2002

(51) Int. Cl. B25B 13/00

(52) U.S. Cl. 81/59.1

(57) ABSTRACT

A wrench includes a body with an engaging ring rotatably engaged with a hole defined in a head of the body and a plurality of wedge-shaped gaps are defined between an inside of the head and the outer periphery of the engaging ring. A resilient member and a roller are engaged in each gap. An imaginary line “cs” is formed from a center “s” of the roller to a center “c” of the hole. Each roller applies a force at point “a” in the hole of the wrench. An off-set distance “h” is defined between the line “cs” and line “ca”. An angle “w1” defined between the line “cs” and line “ca” is in the range of 5 to 20 degrees.

### FIELD OF THE INVENTION

The present invention relates to a wrench that includes an engaging ring with a plurality of wedge-shaped gaps between an inside of the head of the tool and the outer periphery of the engaging ring. Rollers are movably engaged in the gaps so that the engaging ring is forced together with the head or is rotated independently from the head.

### BACKGROUND OF THE INVENTION

A conventional wrench 10 known to applicant is shown in FIG. 1 and generally includes a body 11 and an engaging ring 12 which is rotatably received in a hole 111 in the head of the body 11. A plurality of wedge-shaped gaps 13 are defined between an inside of the head and the outer periphery of the engaging ring 12. Each gap 13 has a resilient member 14 and a roller 15 received therein. The roller 15 rolls into the deeper end 131 of each gap 13 when the body 11 is rotated in a first direction so that the engaging ring 12 is not firmly urged by the rollers 15, the head is rotated independently while the engaging ring 12 is remained still. When the body 11 is rotated in an opposite direction relative to the first direction, the rollers 15 roll into the narrow end 132 of each gap 13 and firmly urge the engaging ring 12 which is then co-rotated with the body 11. Nevertheless, the wrench cannot provide large torque so that the rollers and/or the engaging ring are easily damaged when outputting a large torque.

The present invention intends to provide a wrench wherein the dimension and positions of the rollers are specifically designed to obtain an optimized structural strength so as to output a large torque.

### SUMMARY OF THE INVENTION

In accordance with one aspect of the present invention, there is provided a wrench which includes a body with an engaging ring rotatably engaged with a hole defined in a head of the body and a plurality of wedge-shaped gaps are defined between an inside of the head and the outer periphery of the engaging ring. Each gap receives a resilient member and a roller. An imaginary line “cs” is formed from a center “s” of the roller to a center “c” of the hole. Each roller applies a force at point “a” in the hole of the wrench. An off-set distance “h” is defined between the line “cs” and line “ca”. An angle “w1” defined between the line “cs” and line “ca” is in the range of 5 to 20 degrees.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 shows a conventional wrench;

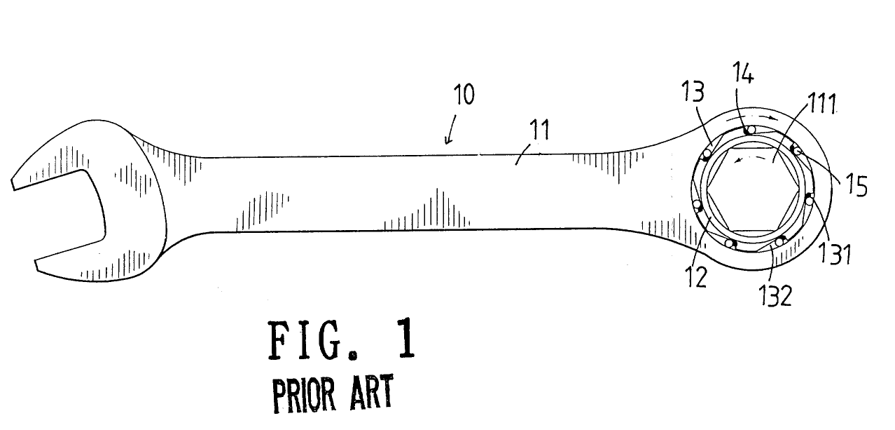

FIG. 2 is a plan view to show the wrench of the present invention;

FIG. 3 shows forces applied onto the rollers of the wrench of the present invention, and

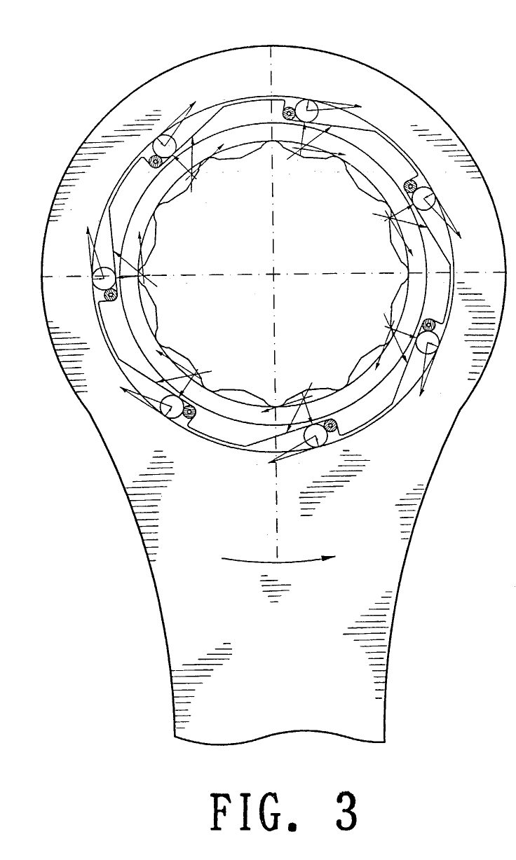

FIG. 4 shows an enlarged view of the roller and the resilient member in the wrench of the present invention.

### DETAILED DESCRIPTION OF THE PREFERRED EMBODIMENT

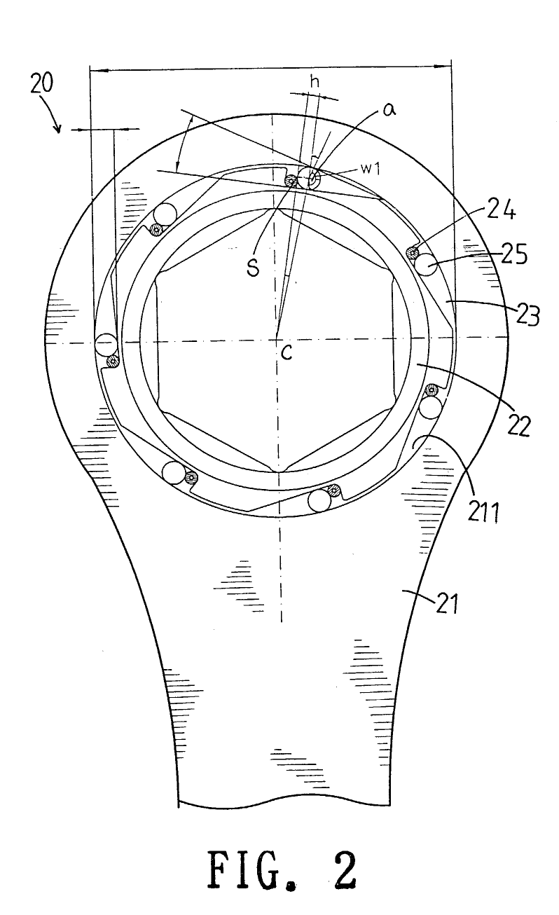

Referring to FIG. 2, the wrench 20 of the present invention comprises a body 21 and an engaging ring 22 which is rotatably engaged with a hole 211 in a head of the wrench 20. A plurality of recesses defined in an outer periphery thereof so as to form a plurality of wedge-shaped gaps 23 between an inside of the head and the outer periphery of the engaging ring 22. A resilient member 24 and a roller 25 are engaged in each gap 23. An imaginary line “cs” is formed from a center “s” of the roller 25 to a center “c” of the hole 211. Each roller 25 applies a force at point “a” in the hole 211 of the wrench 20. An off-set distance “h” is defined between the line “cs” and line “ca”. An angle “w1” defined between the line “cs” and line “ca” is in the range of 5 to 20 degrees.

When in use, as shown in FIG. 2, due to the distance “h”, the engaging ring 22 may output a torque with a limited angle of rotation. A force “Fa” and a force “Fb” are generated because of the “h” and all the forces applied to the engaging ring 22 are happened at the thickness in the tangential direction. The thickness and the structure in the direction is the largest so that a large torque can be output. “Fa” is larger than “Fb” means the driving force is larger than the force of deformation of the engaging ring 22 so that a larger torque is obtained.

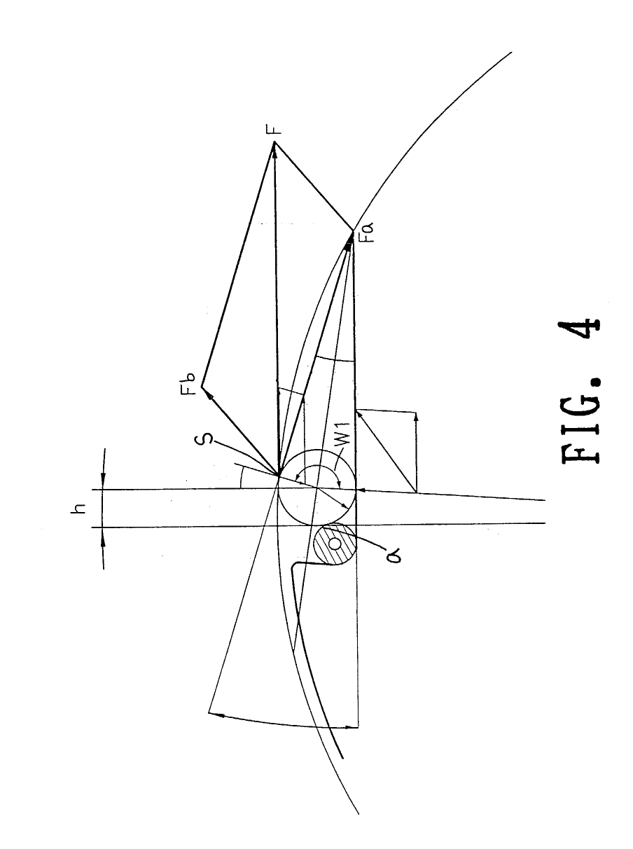

As shown in FIG. 4, when the rollers 25 are forced to have a “h” distance by the resilient members 24, that is to say, the rollers 25 are rotated an angle and generates a force “Fa”, the engaging ring 22 has a resistant force “Fb” to resist the deformation. The “Fa” is always larger than that of the “Fb”, so that when the angle w1 is in the range of 5 to 20 degrees, the “Fa” reaches the maximum value and a largest torque is obtained.

While we have shown and described the embodiment in accordance with the present invention, it should be clear to those skilled in the art that further embodiments may be made without departing from the scope of the present invention.

What is claimed is:

1. A wrench comprising:
a body with an engaging ring rotatably engaged with a hole defined in a head of the body, a plurality of recesses defined in an outer periphery thereof so as to form a plurality of wedge-shaped gaps between an inside of the head and the outer periphery of the engaging ring, a resilient member and a roller engaged in each gap, an imaginary line “cs” being formed from a center “s” of the roller to a center “c” of the hole, each roller applying a force at point “a” in the hole of the wrench, an off-set distance “h” defined between the line “cs” and line “ca”, an angle “w1” defined between the line “cs” and line “ca” and being in the range of 5 to 20 degrees.
